(19) United States
(12) Patent Application Publication
(10) Pub. No.: US 2009/0203510 A1
(43) Pub. Date: Aug. 13, 2009

(54) CYLINDER OF FOLDER

(76) Inventors: Shigeaki Kurihara, Noda-shi (JP); Hidenobu Tsurunaga, Noda-shi (JP)

Correspondence Address: BIRCH STEWART KOLASCH & BIRCH, PO BOX 747, FALLS CHURCH, VA, 22040-0747, US

(21) Appl. No.: 12/349,545

(22) Filed: Jan. 7, 2009

(30) Foreign Application Priority Data
Feb. 8, 2008 (JP) 2008-028430

(51) Int. Cl. B31F 1/10

(52) U.S. Cl. 493/434

(57) ABSTRACT

In a cylinder of a folder in which a web being transported is cut by a cut-off knife, and a sheet formed by cutting performed by the cut-off knife is folded to form a signature, at least a part of the surface of the cylinder, which the sheet or the signature contacts, is a rough surface.

### BACKGROUND OF THE INVENTION

1. Field of the Invention

This invention relates to a cylinder of a folder for transporting a sheet, and more particularly, to a transport cylinder of a folder in a web rotary press.

2. Description of the Related Art

A folder in a web rotary press is provided with various transport cylinders which hold and transport a sheet. By the action of the various transport cylinders, a web (sheet) dried and cooled after printing is cut to a predetermined length, and the cut web is folded in its widthwise direction or lengthwise direction to form a signature from the web.

JP-A-1-192668, for example, discloses a folder comprising a cut-off cylinder having a cut-off knife and a first pin, a folding cylinder having a second pin, a cut web receiver, and a sucker blade, and a jaw cylinder having a gripper board, and allowing these cylinders to be rotated, with their peripheral surfaces opposing each other (see FIGS. 1 and 3). In this folder, the motions of the first pin and the second pin are controlled in accordance with the rotations of the cut-off cylinder and the folding cylinder. That is, a web to be cut is transported to a position where the cut-off knife of the cut-off cylinder and the cut web receiver of the folding cylinder oppose each other, and a first cut web which has been formed by cutting is held by the first pin. The cut-off cylinder is rotated once, with the first cut web being held by the first pin. Then, the first cut web, which has been transported again to the position where the cut-off knife of the cut-off cylinder and the cut web receiver of the folding cylinder oppose each other, and a second cut web, which has been cut by being transported to the position where the cut-off knife of the cut-off cylinder and the cut web receiver of the folding cylinder oppose each other, are superposed and transported by the folding cylinder while being held by the second pin.

In the above-mentioned folder, the leading end side of a sheet or signature is held by a holding means provided in each cylinder, such as the pin or the gripper board. However, the trailing end side of the sheet or signature is only wrapped around the peripheral surface of each cylinder, and is not held by any member. Thus, the trailing end side of the sheet or signature may slip on the peripheral surface of the cylinder, act violently, and contact an instrument disposed near the cylinder.

### SUMMARY OF THE INVENTION

The present invention has been proposed in light of the above-described problems. It is an object of the invention to provide a cylinder of a folder which can suppress the slippage of a sheet or a signature held on the peripheral surface of the cylinder.

A first aspect of the present invention is a cylinder of a folder in which a web being transported is cut by a cutting apparatus, and a sheet formed by cutting performed by the cutting apparatus is folded to form a signature, wherein at least a part of a surface of the cylinder, which the sheet or the signature contacts, is a rough surface for preventing slippage of the sheet or the signature on the surface of the cylinder.

A second aspect of the present invention is the cylinder of a folder according to the first aspect, wherein surface roughness Ra of the rough surface may be represented by 0.2 μm≦Ra.

A third aspect of the present invention is the cylinder of a folder according to the second aspect, wherein the surface roughness Ra of the rough surface may be represented by Ra≦150 μm.

A fourth aspect of the present invention is the cylinder of a folder according to the first aspect, wherein at least the part of the surface of the cylinder, which the sheet or the signature contacts, may be a slip preventing member supported detachably by the cylinder, and surface roughness Ra represented by 0.2 μm≦Ra≦150 μm may be imparted to the slip preventing member.

A fifth aspect of the present invention is the cylinder of a folder according to the fourth aspect, wherein a plurality of holding means for holding the sheet or the signature may be provided in a circumferential direction of the cylinder, and the slip preventing member may be disposed between the plurality of holding means.

A sixth aspect of the present invention is the cylinder of a folder according to the fourth aspect, wherein holding means for holding the sheet or the signature may be provided at locations where the cylinder is circumferentially divided into 3 equal parts, and the slip preventing members may be disposed between the holding means located adjacently.

A seventh aspect of the present invention is the cylinder of a folder according to the fourth aspect, wherein the slip preventing member may be detachably supported in the cylinder by a bolt.

An eighth aspect of the present invention is the cylinder of a folder according to the fourth aspect, wherein the slip preventing member may be formed to have a surface substantially continuous with a peripheral surface of the cylinder when the slip preventing member is supported in the cylinder.

A ninth aspect of the present invention is the cylinder of a folder according to the first aspect, wherein the rough surface may be formed by abrasive blasting or thermal spraying.

A tenth aspect of the present invention is the cylinder of a folder according to the first aspect, wherein the cylinder may be at least one of a correct and cutting cylinder, a folding cylinder, a jaw cylinder, and a reduction cylinder of the folder.

An eleventh aspect of the present invention is the cylinder of a folder according to the fourth aspect, wherein the cylinder may have a notch in a peripheral surface thereof, and the slip preventing member may be detachably supported in the notch.

According to the cylinder of a folder concerned with the present invention, in which a web being transported is cut by the cutting apparatus, and a sheet formed by cutting performed by the cutting apparatus is folded to form a signature, at least a part of the surface of the cylinder, contacted by the sheet or the signature, is a rough surface. Thus, the slippage of the sheet or the signature held on the peripheral surface of the cylinder can be suppressed.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic side view of a folder in which a cylinder of the folder according to a first embodiment of the present invention is disposed;

FIG. 2 is a schematic configurational drawing of a transport path of the folder in which the cylinder of the folder according to the first embodiment of the present invention is disposed; and

FIG. 3 is a schematic view of the cylinder of the folder according to the first embodiment of the present invention.

### DETAILED DESCRIPTION OF THE INVENTION

An embodiment of a cylinder of a folder according to the present invention will be described concretely with reference to the accompanying drawings.

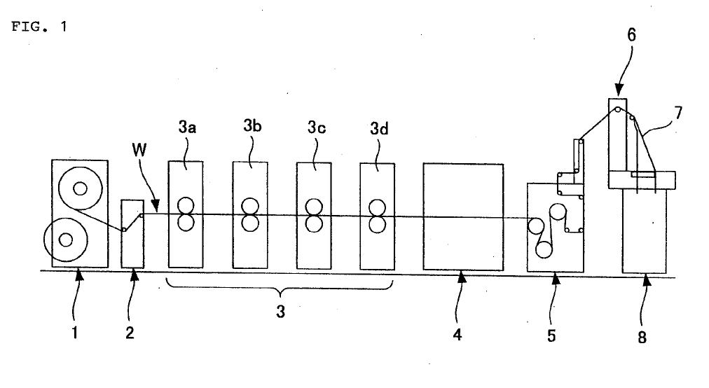

An embodiment of the present invention, in which the cylinder of the folder according to the present invention is applied to a cutting standby cylinder disposed in a folder of a web rotary press, is now described by reference to FIGS. 1 to 3.

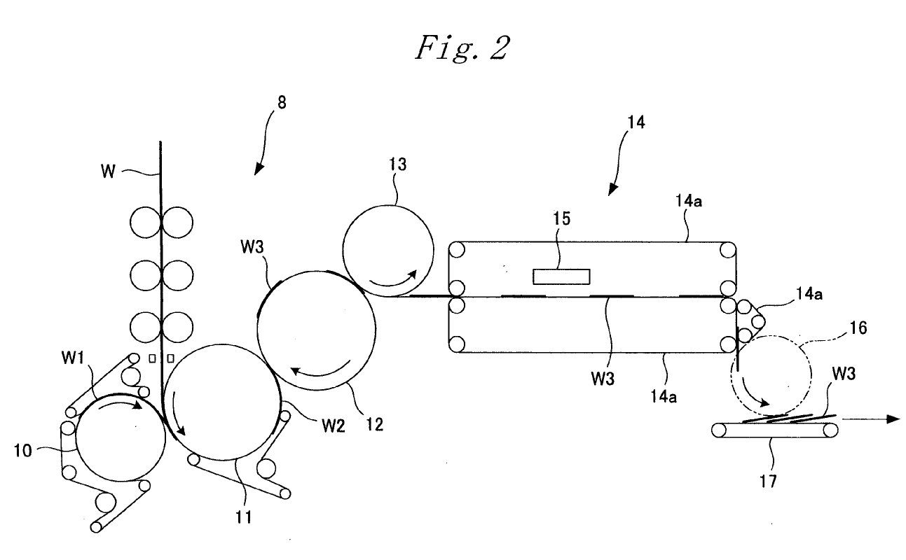

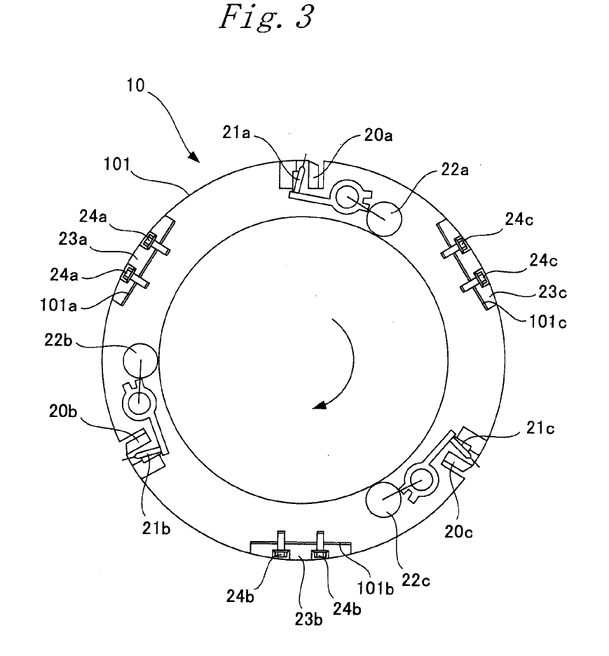

FIG. 1 is a schematic side view of the folder, FIG. 2 is a schematic configurational drawing of its transport path, and FIG. 3 is a schematic view of a transport cylinder (cutting standby cylinder).

In a web rotary press, as shown in FIG. 1, a web W is continuously fed from a feeder 1 and an infeed unit 2, and passed through a first printing unit 3a to a fourth printing unit 3d of a printing apparatus 3 to undergo various printings. The thus printed web W is heated and dried in a drying unit 4, and then cooled in a cooling unit 5. Then, the web W is subjected to tension adjustment and directional change in a web path unit 6, is longitudinally folded along the transport direction by a former 7, and is then fed into a folder 8.

Within the folder 8, as shown in FIG. 2, the web W fed between a cutting standby cylinder (cylinder) 10 and a folding cylinder (cylinder) 11 is cut to predetermined dimensions by a cut-off knife 20a, 20b or 20c (to be described later; see FIG. 3) in the cutting standby cylinder 10. The leading end of the web which has been cut (a sheet or a cut web), W1, is once held by a pin 21a, 21b or 21c (to be described later; see FIG. 3) in the cutting standby cylinder 10, and the cut web W1 is circumferentially rotated in this state about the cutting standby cylinder 10. Then, the leading end of the web W located downstream in the transport direction of the cut web is held by a pin (not shown) of the folding cylinder 11, whereas the cut web W1 circumferentially rotated about the cutting standby cylinder 10 is passed on to the folding cylinder 11. The leading end of this cut web W1 is also held by the above-mentioned pin of the folding cylinder 11. Then, the web W, which is located downstream in the transport direction of the cut web, is cut to predetermined dimensions by the cut-off knife 20a, 20b or 20c of the cutting standby cylinder 10 to have a trailing end. On the folding cylinder 11, the former cut web and the latter cut web are superposed to form a double-superposed cut web W2, which is subjected to single parallel folding by a first jaw cylinder (cylinder) 12. The resulting single-parallel-folded signature (W3) is folded widthwise, if required, by a second jaw cylinder (cylinder) 13 at an arbitrary position in the transport direction of the signature.

The signature W3 is transported by a transport apparatus 14 provided laterally of (rightwardly of in FIG. 2) the second jaw cylinder 13, and swung downward by a chopper blade 15 disposed above within the transport apparatus 14, whereby the signature W3 transported by transport belts 14a of the transport apparatus 14 is chopper-folded. A fan wheel 16 is provided downstream in the transport direction of the transport belts 14a of the transport apparatus 14. Further, a delivery conveyor 17 is provided below the fan wheel 16.

In the above-described folder 8, therefore, the web W is cut between the cutting standby cylinder 10 and the folding cylinder 11, and each cut web W1 is alternately held by the cutting standby cylinder 10 and the folding cylinder 11. The cut web W1 held by the cutting standby cylinder 10 is passed on to the folding cylinder 11, and the double-superposed cut web W2 is held and transported by the folding cylinder 11.

The above-mentioned cutting standby cylinder 10, as shown in FIG. 3, is composed of a triple-diameter cylinder in which the cut-off knives 20a to 20c for cutting the web W to predetermined dimensions, and a plurality of axially spaced parallel pins (holding devices) 21a to 21c are arranged at positions where the peripheral surface 101 of the cutting standby cylinder 10 is circumferentially divided into 3 equal parts. The pins 21a to 21c are urged to protrude from the peripheral surface 101 of the cutting standby cylinder 10 by urging members (torsion bars) which are not shown. These pins 21a to 21c are caused to sink by the movement of cam followers 22a to 22c.

In the cutting standby cylinder 10, depressions (notches) 101a to 101c are formed in the peripheral surface 101 thereof between the circumferentially adjacent pins over the entire width of the cylinder 10. Sheet non-slip instruments (slip preventing members) 23a to 23c, which have a higher coefficient of friction than that of the peripheral surface 101 of the cutting standby cylinder 10, are mounted in the depressions 101a to 101c by bolts 24a to 24c. That is, the sheet non-slip instruments 23a to 23c are provided removably on the peripheral surface 101 of the cutting standby cylinder 10. However, the sheet non-slip instruments 23a to 23c are formed to be of nearly the same arcuate shape as that of the peripheral surface 101 of the cutting standby cylinder 10 when they are mounted in the depressions 101a to 101c. By so doing, the slippage of the cut web W1 held by the plurality of pins 21a to 21c can be suppressed, and the cutting standby cylinder 10 can transport the cut web W1 reliably and smoothly.

The surface roughness of each of the sheet non-slip instruments 23a to 23c mentioned above is in the range of 0.2 μm to 150 μm upon processing by abrasive blasting, and in the range of 10 μm to 150 μm upon processing by thermal spraying. That is, the surface (rough surface) of each of the sheet non-slip instruments 23a to 23c has been processed to have surface roughness in the range of 0.2 μm to 150 μm. If the surface roughness Ra of the sheet non-slip instruments 23a to 23c is less than 0.2 μm, the sheet or signature may slip on the peripheral surface of the cylinder, and float over the peripheral surface of the cylinder, contacting an instrument disposed in the vicinity of the cylinder. By so setting the surface roughness Ra of the sheet non-slip instruments 23a to 23c at 0.2 μm or more, the sheet or signature is prevented from slipping on the peripheral surface of the cylinder, thereby avoiding the possibility that the sheet or signature will contact the instrument disposed in the vicinity of the cylinder. If the surface roughness Ra of the sheet non-slip instruments 23a to 23c exceeds 150 μm, on the other hand, the printed surface of the sheet or the printed surface of the signature, which is passed from the cylinder on to a cylinder located downstream and transported, may be scratched upon contact with the rough surface of the cylinder. By so setting the surface roughness Ra of the sheet non-slip instruments 23a to 23c at 150 μm or less, the printed surface of the sheet or the printed surface of the signature is not scratched even upon contact with the rough surface of the cylinder, because the surface roughness is low. As described above, the slippage of the cut web W1 held on the peripheral surface is suppressed. Moreover, the surface roughness of the sheet non-slip instruments 23a to 23c can be adjusted by a conventional technology, so that a marked increase in the manufacturing cost of the sheet non-slip instruments 23a to 23c can be curtailed. The above-mentioned surface roughness refers to a center-line mean roughness Ra which is a value obtained by folding back a roughness profile at its center line, calculating a total of areas surrounded by the roughness profile and the center line, and dividing the total of areas by the length L of the center line.

According to the cutting standby cylinder 10 concerned with the embodiment of the present invention, therefore, at least a part of the surface of the cutting standby cylinder 10, which the cut web W1 contacts, is a rough surface, so that the slippage of the cut web W1 held on the peripheral surface 101 can be suppressed.

As described above, at least a part of the surface of the cutting standby cylinder 10, which the cut web W1 contacts, is the sheet non-slip instrument 23a, 23b or 23c supported detachably on the cutting standby cylinder 10, and the surface roughness Ra represented by 0.2 μm≦Ra≦150 μm is imparted to the sheet non-slip instruments 23a to 23c. Because of these features, when the cut web W1 is transported by the cutting standby cylinder 10, slippage of the cut web W1 held on the peripheral surface 101 of the cutting standby cylinder 10 can be suppressed. Furthermore, the sheet non-slip instruments 23a to 23c are supported detachably on the cutting standby cylinder 10. Thus, the sheet non-slip instruments 23a to 23c can be replaced in accordance with the decline of their function or the duration of their use. Consequently, maintenance work is facilitated, the time required for maintenance work can be shortened, and the entailed cost can be reduced.

As stated earlier, moreover, the sheet non-slip instruments 23a to 23c are arranged between the pins 21a to 21c adjacent in the circumferential direction of the peripheral surface 101 of the cutting standby cylinder 10. Thus, when the cut web W1 is transported, holding of the cut web W1 by the pin (21a, 21b or 21c) and suppression of slippage of the cut web W1 by the sheet non-slip instrument (23a, 23b or 23c) can be performed at different locations in the lengthwise direction of the cut web W1. Hence, when the cut web W1 is transported by the cutting standby cylinder 10, the slippage of the cut web W1 on the peripheral surface 101 of the cutting standby cylinder 10 can be suppressed, and the cutting standby cylinder 10 can transport the cut web W1 even more reliably and smoothly.

The members for allowing the sheet non-slip instruments 23a to 23c to be detachably supported on the cutting standby cylinder 10 are the bolts 24a to 24c. Thus, a marked increase in the cost can be curtailed.

As stated earlier, the present invention relates to a transport cylinder and, concretely, is preferably applied to a cutting standby cylinder, a folding cylinder, a jaw cylinder, or a speed reducing cylinder which has a holding device (e.g., a pin, a gripper board, or a gripper) capable of holding a sheet.

While the present invention has been described in the foregoing fashion, it is to be understood that the invention is not limited thereby, but may be varied in many other ways. For example, in the present embodiment, the sheet non-slip instruments 23a to 23c are provided on the peripheral surface 101 of the cutting standby cylinder (cylinder) 10, as mentioned above. However, the present invention is not limited to the aforementioned embodiment, and makes it possible to provide the sheet non-slip instruments on the peripheral surface of a cylinder having the holding devices for holding the sheet or signature, such as a folding cylinder (cylinder) having a pin, a jaw cylinder (cylinder) having a gripper board, or a speed reducing cylinder (cylinder) having a gripper. By providing the sheet non-slip instruments on the peripheral surface of any of these cylinders, the slippage of the sheet or signature held by the holding devices can be suppressed, as in the aforementioned cutting standby cylinder 10 provided with the sheet non-slip instruments 23 on the peripheral surface 101, so that the cylinder can transport the sheet or signature reliably and smoothly.

Moreover, the surface roughness of the sheet non-slip instruments 23 is adjusted by abrasive blasting or thermal spraying. However, the surface roughness of the sheet non-slip instruments 23 maybe adjusted by other techniques.

Furthermore, the present invention has been described using the cutting standby cylinder 10 having the sheet non-slip instruments 23a to 23c provided on a part of the peripheral surface 101. However, the present invention can use a cutting standby cylinder having the sheet non-slip instruments provided on the entire peripheral surface other than the locations where the pins for holding the cut webs are provided; or a cutting standby cylinder having a plurality of the sheet non-slip instruments between the pins adjacent in the circumferential direction on the peripheral surface. Even such a cutting standby cylinder shows actions and effects similar to those of the aforementioned cutting standby cylinder 10.

Besides, the sheet non-slip instruments 23a to 23c having the surface roughness Ra are detachably supported by the depressions 101a to 101c of the cylinder 10. However, it is also possible to apply treatment, which imparts surface roughness in the aforementioned range, to the peripheral surface of the cylinder. Even a cylinder treated in this manner exhibits actions and effects similar to those of the aforementioned cutting standby cylinder 10. Such variations are not to be regarded as a departure from the spirit and scope of the invention, and all such modifications as would be obvious to one skilled in the art are intended to be included within the scope of the appended claims.

What is claimed is:

1. A cylinder of a folder in which a web being transported is cut by a cutting apparatus, and a sheet formed by cutting performed by the cutting apparatus is folded to form a signature,
wherein at least a part of a surface of the cylinder, which the sheet or the signature contacts, is a rough surface for preventing slippage of the sheet or the signature on the surface of the cylinder.

2. The cylinder of a folder according to claim 1, wherein
surface roughness Ra of the rough surface is represented by 0.2 μm≦Ra.

3. The cylinder of a folder according to claim 2, wherein
the surface roughness Ra of the rough surface is represented by Ra≦150 μm.

4. The cylinder of a folder according to claim 1, wherein
at least the part of the surface of the cylinder, which the sheet or the signature contacts, is a slip preventing member supported detachably by the cylinder, and
surface roughness Ra represented by 0.2 μm≦Ra≦150 μm is imparted to the slip preventing member.

5. The cylinder of a folder according to claim 4, wherein
a plurality of holding means for holding the sheet or the signature are provided in a circumferential direction of the cylinder, and
the slip preventing member is disposed between the plurality of holding means.

6. The cylinder of a folder according to claim 4, wherein
holding means for holding the sheet or the signature are provided at locations where the cylinder is circumferentially divided into 3 equal parts, and
the slip preventing members are disposed between the holding means located adjacently.

7. The cylinder of a folder according to claim 4, wherein
the slip preventing member is detachably supported in the cylinder by a bolt.

8. The cylinder of a folder according to claim 4, wherein
the slip preventing member is formed to have a surface substantially continuous with a peripheral surface of the cylinder when the slip preventing member is supported in the cylinder.

9. The cylinder of a folder according to claim 1, wherein
the rough surface is formed by abrasive blasting or thermal spraying.

10. The cylinder of a folder according to claim 1, wherein
the cylinder is at least one of a correct and cutting cylinder, a folding cylinder, a jaw cylinder, and a reduction cylinder of the folder.

11. The cylinder of a folder according to claim 4, wherein
the cylinder has a notch in a peripheral surface thereof, and
the slip preventing member is detachably supported in the notch.
